(19) United States
(12) Patent Application Publication
(10) Pub. No.: US 2023/0124723 A1
(43) Pub. Date: Apr. 20, 2023

(54) AN APPARATUS FOR PRODUCING A MULTIPLICITY OF PHOTONS COMPRISING QUANTUM-ENTANGLED SINGLE-PHOTON STATES

(71) Applicant: Università degli Studi di Trento, Trento (IT)

(72) Inventors: Lorenzo PAVESI, Trento (IT); Valter MORETTI, Trento (IT); Sonia MAZZUCCHI, Trento (IT); Davide PASTORELLO, Pergine Valsugana (TN) (IT); Matteo PASINI, Rotterdam (NL)

(73) Assignee: Università degli Studi di Trento, Trento (IT)

(21) Appl. No.: 17/911,694

(22) PCT Filed: Mar. 10, 2021
(86) PCT No.: PCT/IB2021/051980

§ 371 Date: Sep. 15, 2022

(30) Foreign Application Priority Data
Mar. 16, 2020 (IT) 102020000005521

(51) Int. Cl. G02B 27/28; H01S 3/00; G02B 26/06

(52) U.S. Cl. CPC G02B 27/286; H01S 3/005; G02B 26/06

(57) ABSTRACT

Apparatus for producing a multiplicity of photons having quantum-entangled single-photon states is provided. The single photon includes two quantum-entangled degrees of freedom, and the apparatus includes a source apparatus of the multiplicity of photons having quantum-entangled single-photon states including first- and second-generation stages. The first stage includes a first element having a source generating a multiplicity of photons, the first element selects a first degree of freedom of two degrees of freedom of the single photon, which includes only one pair of values, and a second element that selects a second degree of freedom of two degrees of freedom of the single photon. The second degree of freedom includes only one pair of values, the second stage: generates a coherent superposition of the two degrees of freedom of the single photon; selects one value of a first and a second of said two degrees of freedom.

The present invention relates to an apparatus for producing photons comprising quantum-entangled single-photon states.

The photons produced comprise single-photon states that present quantum entanglements between different degrees of freedom of the single photon, that is, the apparatus produces photons in which the single photon has two quantum-entangled degrees of freedom.

In the state of the art, photon production apparatuses in which the photons are in “quantum-entangled” states are known. These apparatuses comprise sources of quantum-entangled photons generated by coherent photon sources fed at high power, for example sources of Light Amplification by Stimulated Emission of Radiation (acronym LASER) at high power. These coherent sources are adapted to produce both pairs of photons in quantum-entangled states, i.e. adapted to produce “interparticle entanglement”, and single photons in which the single photon has two degrees of freedom in quantum entanglement, i.e. adapted to produce “intraparticle entanglement”.

The state of the art teaches that the “intraparticle entangled” state is formed starting from a pure single-photon state. For the generation of this pure state, either a single-photon deterministic source, such as “quantum dots” or a diamond defect, or a single-photon “heralded” source is used. The “heralded” single-photon source comprises a photon source that generates two temporally entangled photons following parametric processes in non-linear crystals, nfor example spontaneous non-linear optical processes are induced through a power LASER in which processes a single photon generates, in turn, two entangled photons, called in scientific jargon “spontaneous parametric downconversion”, or in which two photons generate two other entangled photons, this process being referred to as “four wave mixing”. These spontaneous processes are improbable, with an efficiency of the order of −40 dB, that is a pair generated every ten thousand photons, for which they require power LASERs. The pair of photons is then spatially separated and a photon of the pair is detected, thus announcing the presence of the other photon in the measurement apparatus. In this way one is certain about the presence of a single photon as the low efficiency of the process for generating pairs of entangled photons makes the presence of a state with two photons improbable.

Disadvantageously, coherent photon sources consume a lot of energy to produce such power in order to generate photons in quantum-entangled states in non-linear materials for parametric processes.

Disadvantageously, such coherent and high-power sources are difficult to miniaturize.

Disadvantageously, the prior art does not teach how to use incoherent sources to produce quantum-entangled single-photon states.

Disadvantageously, the prior art does not teach how to use incoherent sources for producing quantum-entangled single-photon states and for detecting the existence thereof.

The object of the present invention consists in realising a source apparatus of quantum-entangled single-photon states. The apparatus is preferably low cost. Advantageously, the apparatus requires low power. Preferably, the apparatus requires a lower energy consumption than known apparatuses. Preferably, the apparatus carries out a lower heat dissipation than known apparatuses. Preferably, the apparatus can be lightweight. Advantageously, the apparatus can be compact. Preferably, the apparatus can be miniaturizable.

According to the invention, one of the above objects is achieved with a source apparatus of quantum-entangled single-photon states according to claim 1.

Another object of the present invention consists in realising an integrated photonic circuit which comprises a source apparatus of quantum-entangled single-photon states.

According to the invention, this other object is achieved with an integrated photonic circuit according to claim 21.

Other features are comprised in the dependent claims.

The features and advantages of the present invention will be more apparent from the following description, which is to be understood as exemplifying and not limiting, with reference to the appended schematic drawings, wherein:

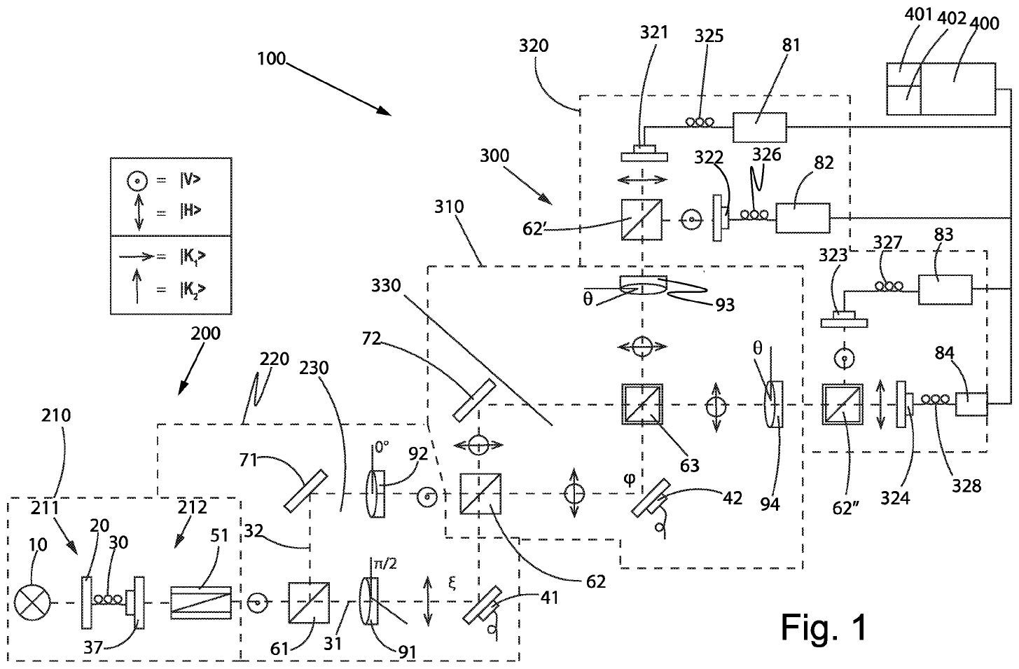

FIG. 1 is a schematic view of an apparatus for producing and detecting quantum-entangled single-photon states, i.e. “intraparticle entanglement” comprising a source apparatus of quantum-entangled single-photon states according to the present invention and an apparatus for verifying the presence of quantum-entangled single-photon states, wherein the source apparatus comprises a first stage comprising an incoherent source of photons, an interference filter and a polarizer, a second stage for generating quantum-entangled single-photon states, and wherein the verification apparatus comprises a first preparation stage and a second detection stage;

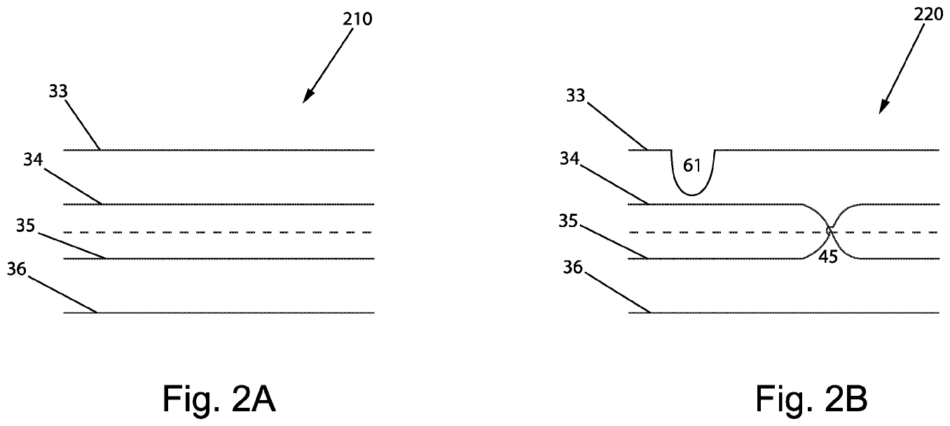

FIG. 2 shows an alternative configuration scheme realised in integrated optics and with waveguides of an alternative second generation stage 220 which generates single-photon states in quantum entanglement with respect to each other, using different degrees of freedom compared to the scheme of FIG. 1;

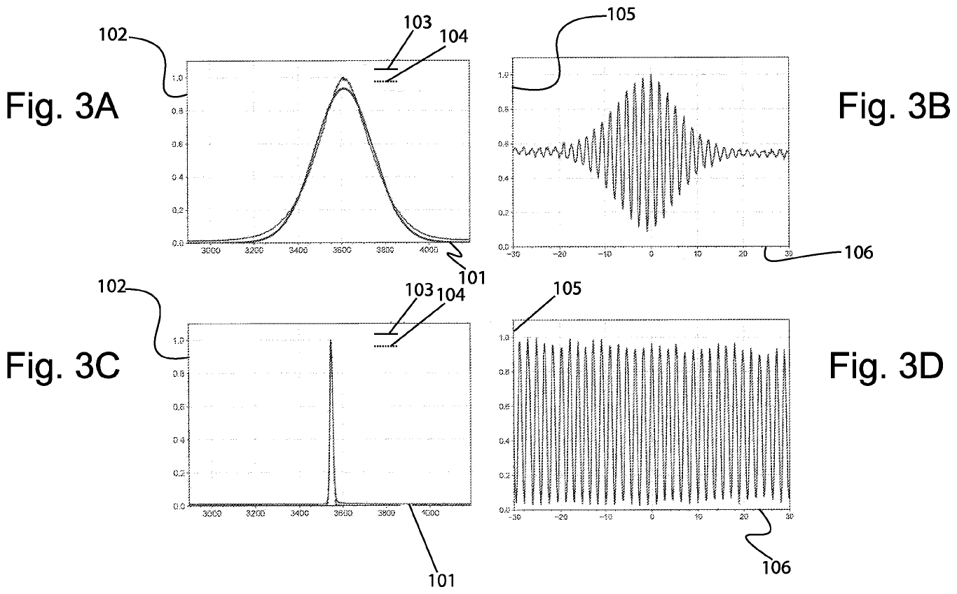

FIGS. 3A-D show a comparison between an unfiltered and filtered spectrum of the source and the corresponding auto-entanglement spectra;

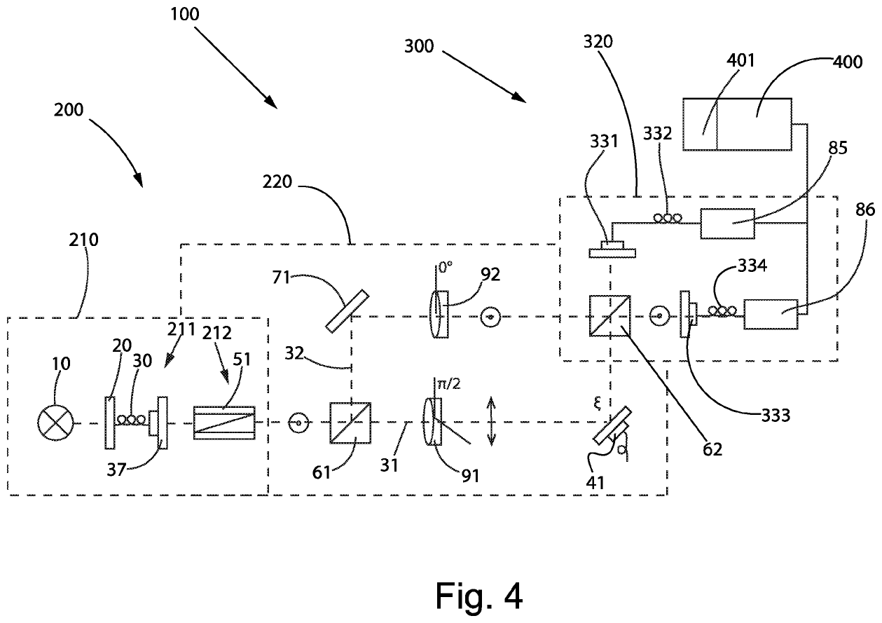

FIG. 4 shows a schematic view of an apparatus for producing and detecting quantum-entangled single-photon states, in which the verification apparatus is alternative and comprises an alternative second detection stage;

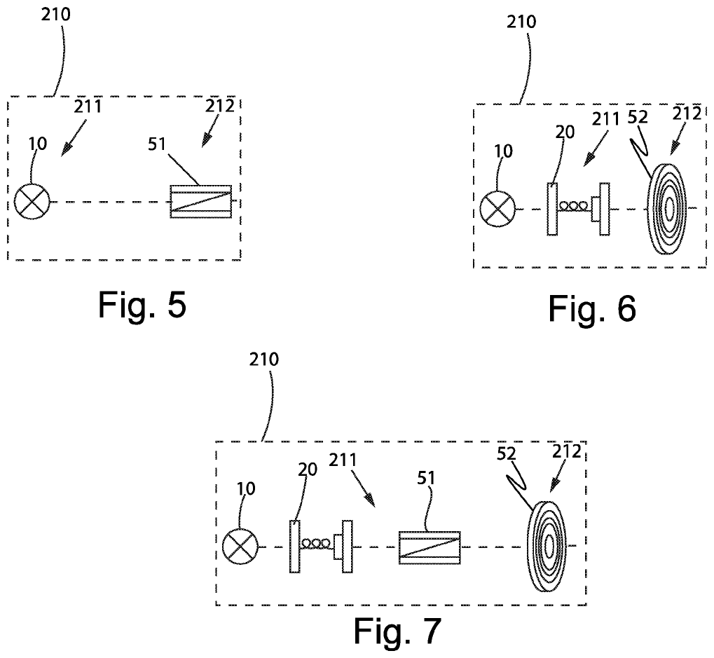

FIG. 5 shows only an alternative first stage of the source apparatus comprising an attenuated LASER photon source and a polarizer;

FIG. 6 shows only an alternative first stage of the source apparatus comprising an incoherent source, an interference filter and a q-plate;

FIG. 7 shows only an alternative first stage of the source apparatus comprising an incoherent source, an interference filter, a polarizer and a q-plate.

With reference to the aforementioned figures and in particular FIG. 1, an apparatus for producing a multiplicity of photons comprising quantum-entangled single-photon states is shown. The apparatus 100 according to the present invention comprises a source apparatus 200 generating a multiplicity of photons comprising single-photon states that are quantum-entangled, i.e. each single photon comprising single-photon quantum-entangled states comprises two quantum-entangled degrees of freedom.

The apparatus 100 can preferably comprise an apparatus 300 for verifying the presence of quantum-entangled single-photon states.

The source apparatus 200 comprises a first generation stage 210 and a second generation stage 220.

The first generation stage 210 generates a multiplicity of photons, wherein each photon of the multiplicity of photons comprises a defined state.

The second generation stage 220 emits an outgoing beam of photons.

Each single photon of the beam coming out of the second generation stage 220 comprises a quantum state comprising a pair of independent degrees of freedom which are in quantum entanglement. These states are called “intraparticle entangled” or “Single Photon Entanglement” (SPE) states.

The first generation stage 210 comprises a first element 211 that selects a first degree of freedom, wherein said first degree of freedom comprises only one pair of values, and a second element 212 that selects a second degree of freedom, wherein said second degree of freedom comprises only one pair of values.

The first element 211 comprises any photon source 10 (both coherent and incoherent), and, in this preferred non-limiting example, an interference filter 20 and the second element 212 comprises a polarizer 51.

The second generation stage 220 selects a value of a first and a second of the two degrees of freedom and the selection does not determine the value of the other degree of freedom of the two degrees of freedom.

The verification apparatus 300 comprises a first preparation stage 310 at a detection of the single photons which are generated by the source apparatus 200 and a second detection stage 320 of the single photons.

Let us analyse specifically the first stage 210 of the source apparatus 200.

The source 10 produces a multiplicity of photons.

It is emphasised that the photon source 10 is any photon source, for example an attenuated LASER, or an incoherent light source such as for example a light emitting diode (acronym LED) or a light source lamp that emits in the electromagnetic spectrum of the visible or a thermal source that emits in the electromagnetic infrared spectrum or other incoherent sources.

Advantageously, the incoherent sources can be miniaturized and are already used within integrated photonic circuits of the state of the prior art. For example LEDs can be integrated into optical circuits. For example, even simple p/n junctions operated in reverse polarization conditions in the avalanche regime can be integrated into optical circuits.

As shown in FIGS. 1, 3, 4, 6 and 7 for the source 10 of incoherent and attenuated light for producing quantum-entangled single-photon states it is necessary to maintain the coherence thereof at least of the first order within the time resolution of the verification apparatus 300. The condition for verifying that the source apparatus 200 produces quantum-entangled single-photon states is that the coherent superposition of two states, that is, between the degrees of freedom of the single photon, is maintained.

When the source 10 is an incoherent source, the present invention maintains the first-order coherence of the degrees of freedom in quantum entanglement through an interference filter 20 applied downstream of the source 10. In this case the first element 211 comprises both the incoherent source 10 and the interference filter 20.

The interference filter 20 and the polarizer 51 serve to define the state of the single photons at the input of the second generation stage 220 of the coherent superposition of the two degrees of freedom of the single photon, which is the single-photon entangled state SPE.

Alternatively, as shown in FIG. 5, when the source is an attenuated LASER, it is not necessary to use an interference filter 20 to maintain the first-order coherence of the degrees of freedom in quantum entanglement. In this alternative, the first element 211 comprises the attenuated LASER source 10 without the interference filter 20.

Preferably when the source 10 is an attenuated LASER, the source 10 is attenuated in such a way that a photon generation frequency is significantly lower than a dynamic range of single photon detectors used for a subsequent measurement by means of a detector. As an alternative to the dynamic range of the detector, it is possible to predict if it is an inverse of the dead time of the detector. Dynamic range means a range of photon fluxes entering the detector used for the measurement, in which the incoming photons cause a linear response of the detector. Dead time means a time interval within which the detector is not sensitive to incident photons due to a previously detected event. Significantly lower refers to the photon flux and is meant to be of an order of magnitude of a hundred times lower.

As shown in FIGS. 1, 3, 4, 6 and 7 in the case of an incoherent source 10, the interference filter 20 is a band-pass filter centred around a specific wavelength that depends on a peak in wavelength of the incoherent source 10. The wavelength of the photons can be chosen according to the source 10. In the example tested, for example, the source 10 is a LED and the interference filter 20 shows a width at half height (FWHM, acronym for Full Width at Half Maximum) of 1 nm and is centred at the wavelength of 531 nm. The source 10 used is a 5 mm through hole LED and emits a spectrum that can be approximated with a Gaussian curve with a wavelength peak of 517 nm and a spectral width of 30 nm at the FWHM as shown in FIG. 3A.

FIG. 3A is a graph showing the normalised power spectrum 102 measured in W/W of the LED source as a function of the measured frequency 101 in THz. The graph of FIG. 3A shows the power spectrum measured without filter, represented by a solid line 103, and the power spectrum parameterized into a Gaussian, represented by a dotted line 104.

The FWHM 1 nm selection band interference filter 20 is approximable into another Gaussian curve centred at the specific wavelength of 531 nm.

The application of the interference filter 20 to the LED source 10 is shown in FIG. 3C. FIG. 3C is a graph showing the normalised power spectrum 102 measured in W/W of the LED source as a function of the measured frequency 101 in THz. The graph of FIG. 3C shows the power spectrum downstream of the interference filter 20 as measured, represented by a solid line 103, and the power spectrum described by a Gaussian, represented by a dotted line 104.

Advantageously, the interference filter 20 allows increasing the coherence of the source 10 within the time resolution interval of the measurement system of the verification apparatus 300.

It is possible to use interference filters centred at other wavelengths depending on the wavelength peak of the incoherent source 10 used. A value close to the peak in wavelength of the source 10 is advantageously taken in this test to advantageously have better statistics, but it is also possible to use other parts of the spectrum depending on the needs and the source used. The selected FWHM 1 nm interval of the interference filter is such as to advantageously increase the first-order coherence of the degrees of freedom in quantum entanglement of the incoherent and attenuated source 10 used. It is possible to use other intervals which depend on the wavelength of the photons emitted by the incoherent and attenuated source 10 used. The width of the interference filter 20 depends on the temporal resolution of the measurement system.

The characteristics of the interference filter 20 are determined by the capacity of the system that will use the photons to count the single photons, that is, by the response time of the measurement system.

It is possible to provide an alternative incoherent and attenuated source 10, for example a full spectrum halogen lamp comprised between 360 and 2400 nm which has been filtered at 531 nm by the same interference filter 20 used for the LED source 10.

The generation does not depend on whether an input state to the second generation stage 220 of the electromagnetic field is a coherent superposition of pure states or whether it is a statistical mixture of pure states.

Since the source apparatus 200 acts separately on the single-photon states, the multiplicity of photons generated by the first generation stage 210 of the source apparatus 200 does not influence the generation of quantum-entangled single-photon states generated by the second generation stage 220.

Furthermore, the generation of quantum-entangled single-photon states does not depend on the statistics of photons generated by the first generation stage 210, it therefore follows that they can be generated by incoherent and attenuated sources 10 of photons such as thermal sources, visible light lamps or LED.

The condition for verifying that the source 220 produces quantum-entangled single-photon states is that the coherent superposition of two states of the single photon, that is between the degrees of freedom of the single photon, is maintained.

Advantageously, the quantum entanglement between the degrees of freedom of the single photon occurs for coherent, incoherent and attenuated sources 10 of photons, providing that the first order of coherence is maintained between the degrees of freedom used for the quantum entanglement.

Advantageously, incoherent and attenuated sources 10 suitably filtered through a polarization filter and an interference filter 20 allow producing a flux of single photons with “intraparticle entanglement” which are indistinguishable from those generated by a single-photon source, such as a deterministic single quantum dot source or a source of “heralded” photons generated by non-linear optical processes induced by high-power LASERs.

In order to verify the coherence of the spectrum obtained, the setup of the apparatus 100 shown in FIG. 4 is used, which is substantially the apparatus of FIG. 1 except for the first preparation stage 310 of the verification apparatus 300 and comprising only two detectors 85 and 86. This alternative apparatus shown in FIG. 4 is also useful for measuring the auto-entanglement of photons, that is, to verify the state of coherence thereof.

FIG. 3B shows a graph of the auto-entanglement spectrum of the photons generated by the source 10 of FIG. 3A showing a normalised signal 105 in arbitrary units as a function of a delay time 106 in femtoseconds.

FIG. 3D shows a graph of the auto-entanglement spectrum of the photons generated by the source 10 of FIG. 3C downstream of the interference filter 20 which shows the normalised signal 105 in arbitrary units as a function of a delay time 106 in femtoseconds.

The normalised signal 105 is measured by moving a first piezoelectric translation mirror 41 of the source apparatus 200 for an overall interval of 20 μm so as to provide a delay time between two optical paths 31 and 32. The first piezoelectric translation mirror 41 is mounted with a piezoelectric translator which is a piezoelectric actuator mounted on a translator. It should be noted that the oscillation of the filtered signal of the spectrum of the filtered source 10 of FIG. 3D does not significantly decrease in the interval of 20 μm, demonstrating that it is possible to advantageously maintain coherence at least at the first order for quantum-entangled states.

In all the embodiment examples of the present invention, the degrees of freedom of the states are chosen according to a first condition according to which for each degree of freedom only one pair of values is possible and according to a second condition according to which a value of one of the two degrees of freedom does not determine the value of the other degree of freedom.

At the input of the generation stage of the pair of entangled states it is necessary to create a defined state of the photon. The defined state of the photon at the input to the generation stage of the pair of entangled states changes according to the degrees of freedom used.

In the embodiment examples described above and depicted in FIGS. 1, 4, 5 in which the second element 212 comprises the polarizer 51, the first degree of freedom is the direction selected by the first element 211 and the second degree of freedom is the polarization selected by the second element 212. The source 10 is an attenuated LASER, or a source that is incoherent with the interference filter 20.

An embodiment example of the second generation stage 220 of quantum-entangled single-photon states is discussed below, wherein the pair of degrees of freedom in quantum entanglement are the momentum (path) and polarization degrees of freedom.

In this embodiment example, the single photon can follow two distinct paths 31, 32, for example in the air or inside two waveguides. The two paths do not allow the single photon, once inside them, to transit from one path to another, for example the two waveguides must be arranged sufficiently far apart to avoid behaving as couplers (directional coupler), or the two paths must be arranged orthogonally with respect to each other as shown in FIG. 1.

More generally, the single photon comprises a degree of freedom K or path comprising two values: a first momentum k₁ and a second momentum k₂ which represent two propagation vectors with respect to two paths of an apparatus configured for operation.

The first momentum k₁ is a propagation vector along a horizontal direction in FIG. 1 and the second momentum k₂ is a propagation vector along a vertical direction in FIG. 1.

The single photon comprises a degree of freedom of polarization P comprising two values: for example, a vertical polarization V and a horizontal polarization H with respect to a geometric plane on which the apparatus 200 is configured for operation. An alternative possibility is to consider another pair of orthogonal polarization planes (±45°).

Conventionally using the Dirac formalism, or braket notation to describe quantum states:

″k₁ [symbol] ⊗|V [symbol] represents the state of a photon comprising first momentum k₁ and vertical polarization V,

|k₁ [symbol] ⊗|H [symbol] represents the state of a photon comprising first momentum k₁ and horizontal polarization H,

|k₂ [symbol] ⊗|V [symbol] represents the state of a photon comprising second momentum k₂ and vertical polarization V,

|k₂ [symbol] ⊗|H [symbol] represents the state of a photon comprising second momentum k₂ and horizontal polarization H,

Furthermore, the following must apply:

[symbol]

V|H [symbol] =0,

wherein the condition of orthogonal polarizations is represented, and

[symbol]

k₁|k₂ [symbol] =0

Where the condition of independent paths is represented.

In this embodiment example, the quantum-entangled states of the single photon are momentum (path) and polarization and are generically represented as:

$$\vert ψ 〉 = \frac{1}{\sqrt{2}} ( \vert {K}_{1} 〉 \vert {P}_{1} 〉 + \vert {K}_{2} 〉 \vert {P}_{2} 〉 ) ;$$

where K₁ and K₂ are the momenta and P₁ and P₂ are the polarizations, wherein K₁ and K₂ represent the first momentum k₁ or the second momentum k₂ and wherein P₁ and P₂ represent a vertical polarization V and a horizontal polarization H.

In FIG. 1 the first momentum is represented by the horizontal path 31, while the second momentum is represented by the vertical path 32. Different paths can be chosen, as long as the first and second condition are respected.

The degrees of freedom that respect the first and second conditions are the direction which is the first degree of freedom and the polarization which is the second degree of freedom.

More generally, a two-state base is defined for the momentum by choosing two possible paths within a setup, i.e. within an operating configuration of the apparatus 200: H_{M}={|k₁ [symbol] ,|k₂ [symbol] } and a two-state base for the polarization: H_{P}={|V [symbol] ,|H [symbol] }. H_{M} is associated with the first qubit, H_{P} with the second qubit. The space of the two qubits can be represented as a four-dimensional Hilbert space H=H_{M}⊗H_{P}.

For example, the first stage 210 comprises an input optical fibre 30 which is arranged downstream of the interference filter 20 and which collects the photons transmitted by the interference filter 20 and an input collimator 37 which collects the photons transmitted by the input optical fibre 30 and transmits them collimated to the polarizer 51 of the first generation stage 210.

Advantageously, the input optical fibre 30 and the input collimator 37 collimate the photon beam that leaves the interference filter 20 for better statistics.

In the embodiment example shown in FIG. 1, the first generation stage 210 of photons comprises a polarizer 51 of the Glan-Thomson type (GTP, acronym for “Glan-Thomson Polarizer”) which selects a polarization orientation, for example a vertical polarization V of the photon beam which is transmitted by the source 10 of the first stage 210.

The second generation stage 220 comprises a first beam splitter 61 which directs with equal probability the photons leaving the polarizer 51 towards two different optical paths, a horizontal path 31 according to the first momentum k₁ and a vertical path 32 according to the second momentum k₂.

The second generation stage 220 comprises the first piezoelectric translation mirror 41 provided to intercept one of the two paths 31, 32 and which controls a relative phase displacement ξ between the two paths 31, 32. In FIG. 1, the first piezoelectric translation mirror 41 is provided to intercept the horizontal path 31.

The second stage preferably also comprises a first mirror 71 provided to intercept one of the two paths 31, 32. In FIG. 1 the first mirror 71 intercepts the vertical path 32 and reflects the photons of the vertical path 32 changing their direction. The phase displacement accumulated by the presence of the first mirror 71 or by other dispersions is advantageously corrected and compensated by the movement of the first piezoelectric translation mirror 41.

The two paths 31, 32 are then directed towards a second beam splitter 62 of the verification apparatus 300.

The first 61 and the second beam splitter 62 and the first piezoelectric translation mirror 41 and the first mirror 71 form a so-called Mach Zehnder interferometer 230.

The Mach Zehnder interferometer 230 is responsible for a rotation of the qubit momentum in the Bloch sphere.

The first 61, the second 62 and the third beam splitter 63 are of the 50/50 type whereby the single photons are directed with equal probability between one path 31, 32 and the other.

The second stage 220 of the source apparatus 200 comprises a first 91 and a second half-wave plate 92 (acronym HWP). Each half-wave plate 91, 92 rotates the polarization of the photon of one of the two paths 31, 32.

The first half-wave plate 91 is arranged on the horizontal path 31 between the first beam splitter 61 and the first piezoelectric translation mirror 41. The first half-wave plate 91 rotates the polarization of the photon by 90 sexagesimal degrees on the geometric plane x-z.

The second half-wave plate 92 is arranged on the vertical path 32 between the first mirror 71, if provided, otherwise between the first beam splitter 61, and the second beam splitter 62. The second half-wave plate 92 rotates the polarization of the photon by 0 sexagesimal degrees on the geometric plane x-z.

The second stage 220 of the source apparatus 200 produces SPE photons comprising degrees of freedom of the momentum and polarization states in quantum entanglement with respect to each other.

The apparatus 300 preferably comprises the first preparation stage 310 comprising the second beam splitter 62 which collects the quantum-entangled single-photon states generated by the second stage 220 of the source apparatus 200.

The first preparation stage 310 comprises a second Mach Zehnder interferometer 330 comprising a second piezoelectric translation mirror 42, preferably a second mirror 72 and a third beam splitter 63. The second piezoelectric translation mirror 42 is mounted with a second piezoelectric translation mirror.

The second beam splitter 62 of the second Mach Zehnder interferometer 330 directs the photon with equal probability on two different paths orthogonal to each other. The third beam splitter 63 of the second Mach Zehnder interferometer 330 directs the photon with equal probability on two different paths orthogonal to each other. A respective half-wave plate 93, 94 is positioned on each of these last two different paths, which rotates the polarization of the photon of that momentum by a pre-set polarization angle θ on the geometric plane x-z perpendicular to the respective path and between 0 and Greek-pi radians.

Each output path directs the photon on a further second polarization beam splitter 62′, 62″ of the second detection stage 320 of the verification apparatus 300. These polarization beam splitters direct the photon on a path or on another path depending on the polarization state of the photon.

For detecting the single photons the verification apparatus 300 comprises the second detection stage 320. The second detection stage 320 comprises a multiplicity of solid-state photodetectors 81-84 operating in photon counting mode and arranged to form an array so as to count the photons arriving from the first preparation stage 310, i.e. an array of solid-state photodetectors 81-84 operating in photon counting mode. A solid-state photodetector 81-84 of the solid-state photodetector array 81-84 is for example a single-photon photodetector diode (SPAD, acronym for “Single Photon Avalanche Diode”) or a superconducting nanowire device. The photodetector array 81-84 counts the single photons arriving from the different paths defined in stage 300.

The second detection stage 320 comprises output collimators 321-324 for each output path and output optical fibres 325-328 for each output collimator 321-324. Each output collimator 321-324 receives photons from the respective path of the two output paths of the second beam splitter 62′, 62″. Each output optical fibre 325-328 transmits the photon to the respective photodetector 81-84 so that it is recorded which photodetector 81-84 has detected the photon by means of a computer 400 of the apparatus 100, wherein the computer 400 comprising at least one memory 401 to store the counts of the photodetectors 81-84 and at least one processor 402 adapted to process the counts of the photodetectors 81-84 stored in the at least one memory 401.

In order to measure the values of the degrees of freedom of the quantum states of the single photon the computer 400 counts the single photons which are detected by the single solid-state photodetectors of the photodetector array 81-84.

Then the computer 400 assesses the quantum entanglements in terms of violations of Bell's inequality, which is a well-known and commonly accepted test to determine whether the states are quantum entangled, in this regard refer to the scientific article by John Stewart Bell, “On the Einstein Podolsky Rosen (EPR) paradox”, published in 1964 in Physics, volume 1, pages 195-200 (DOI:10.1103/PhysicsPhysiqueFizika.1.195).

The violation of Bell's inequality ensures that the production apparatus 200 produced states of single photons in quantum entanglement, i.e. “intraparticle entanglement”. In particular, the test verifies the violation of the Clauser-Horne-Shimony-Holt inequality (CHSH, acronym formed by the surnames of the authors of the article “Proposed experiment to test local hidden-variable theories” in Physical Review Letters 23, 880-884 dated 1969).

Still alternatively it is possible that the apparatus 100 is configured through other elements in order to produce and detect quantum-entangled single-photon states using other degrees of freedom of the single photon, by using for example other methods of the prior art.

An alternative of the second generation stage 220 of single-photon entangled states provides that it is also possible to quantistically entangle the degrees of freedom of orbital angular momentum with the degrees of freedom of momentum or with the degrees of freedom of polarization.

It is possible to quantistically entangle other degrees of freedom of the single photon such as the optical paths of the single photon, which is discussed below as a further embodiment example of the single-photon entanglement generation stage 200.

The further embodiment example shown in FIGS. 2A and 2B relates to the alternative generation stage 200 and relates to the quantum entanglement between two degrees of freedom of optical paths of the single photon. FIG. 2A represents the first generation stage 210 and FIG. 2B represents the second generation stage 220. In this further alternative embodiment example of the generation stage 200 a single photon can follow four distinct optical paths within respective four waveguides 33-36. The four waveguides 33-36 do not allow the single photon, once it is inside them, to transit from one waveguide to the other, for example the waveguides 33-36 must be arranged far enough to avoid behaving as couplers or as beam splitters. In this case a Hilbert space C⁴ of the states is defined by four orthogonal vectors representing four states of two degrees of freedom, wherein the orthogonality of the vectors represents the condition of not allowing a single photon transit from one waveguide 33-36 to the other.

Alternatively, the waveguides 33-36 can be optical fibres.

The four waveguides 33-36 represent four optical paths which in this embodiment example are arranged parallel to each other and lie on a horizontal geometric plane. A geometric line parallel to the four guides, which we will call centreline, is used as a reference and can identify the four guides in the following way: a first waveguide 33 higher than the centreline, a second waveguide 34 higher than the centreline, a third waveguide 35 lower than the geometric line, a fourth waveguide 36 lower than the centreline. The first top guide 33 is far from the centreline. The second top guide 34 is near the centreline. The first bottom guide 35 is near the centreline, the second bottom guide 36 is far from the centreline. The degrees of freedom of the pair of states of the single photon inserted in the guides are two for the first state: top T and bottom B, and two for the second state: near N and far F, wherein top, bottom, near and far refer to the geometric arrangement of the four waveguides 33-36 in relation to the centreline on the geometric plane of the present example.

For the determination of an optical path, a value is assigned to both degrees of freedom, determining an orthonormal basis in the space of the states:

|T [symbol] ⊗|F [symbol] representing the state of a photon transmitted from left to right through the first waveguide 33: top and far,

|T [symbol] ⊗|N [symbol] representing the state of a photon transmitted from left to right through the second waveguide 34: top and near,

|B [symbol] ⊗|N [symbol] representing the state of a photon transmitted from left to right through the third waveguide 35: bottom and near,

|B [symbol] ⊗|F [symbol] representing the state of a photon transmitted from left to right through the fourth waveguide 36: top and far.

The first element 211 of the first generation stage 210 comprises the source 10 which can be incoherent and also comprise the interference filter 20 or the attenuated LASER source without interference filter 20.

The photon emitted by the source 10 is coupled to one of the four waveguides 33-36 thus determining the initial state of the photon.

In this sense the four waveguides 33-36 represent both the first element 211 and the second element 212 of the first generation stage 210 since the four waveguides 33-36 select both a first degree of freedom and a second degree of freedom of two degrees of freedom of the single photon, wherein said first degree of freedom comprises a single pair of values and said second degree of freedom comprises a single pair of values.

The second generation stage 220 is realised through dedicated optical paths. For example by arranging a coupler (direct coupler) or a 50/50 beam splitter 61 adapted to direct the single photons coming from the first guide 33 with equal probability to the first top guide 33 and the second top guide 34, downstream of the beam splitter 61 the state of the single photon initially inserted in the guide 33, i.e. in the state |T [symbol] ⊗|F [symbol] , becomes:

$$\vert T 〉 ⊗ \frac{1}{\sqrt{2}} ( \vert F 〉 + \vert N 〉 ) .$$

It is possible, as shown in FIG. 2B, to produce a single photon final state in quantum entanglement

$$\frac{1}{\sqrt{2}} ( \vert T 〉 \vert F 〉 + \vert B 〉 \vert N 〉 )$$

at the output of the second generation stage 220 by introducing downstream of the beam splitter 61 a position exchanger 45 between the guide 34 and the guide 35. In this way the state at the output from the guides on the right will be quantum-entangled

$$\frac{1}{\sqrt{2}} ( \vert T 〉 \vert F 〉 + \vert B 〉 \vert N 〉 )$$

when on the left at the input the photon is in the state
   |T [symbol] ⊗|F [symbol] , that is, it enters the guide 33. In this alternative, the second generation stage 220 comprises the beam splitter 61 and the position exchanger 45 arranged as described above.

Alternatively, it is possible to choose any of the guides 33-36 as the input waveguide. In this alternative it is necessary to arrange the beam splitter 61 and the position exchanger 45 appropriately in the second generation stage 220.

More generally and still alternatively it is possible to provide that the first element 211 and the second element 212 of said first generation stage 210 comprise four waveguides 33-36 arranged with respect to each other according to a geometric configuration adapted to allow the identification of geometric correlations with respect to each other in such a way that such identification allows to assign a value to both degrees of freedom of said two degrees of freedom of the single photon, determining an orthonormal basis in the state space which is a Hilbert space C⁴.

Alternatively, it is possible to replace the position degrees of freedom with other observables provided that the first and second condition set out above are respected, for example the pair of near N and far F degrees of freedom can be replaced with a pair of transmission modes of the single photon in waveguide since not even four optical paths are necessary, but a Hilbert space with four orthogonal states is sufficient. Starting from a defined input state generated in the first generation stage 210, it is sufficient to achieve a coherent superposition of the two degrees of freedom of the single photon according to a process as described in the second generation stage 220 of the first or second embodiment example. In this alternative the first element 211 and the second element 212 of the first generation stage 210 comprise two multimode waveguides and the degrees of freedom to achieve the quantum entanglement of the single-photon states are the position and the mode of propagation of the photon in waveguide. In this alternative, the two multimode waveguides are arranged with respect to each other in a geometric configuration adapted to allow the identification of geometric correlations with respect to each other, in such a way that such identification allows to assign a value to a first degree of freedom of said two degrees of freedom of the single photon. The value of the second degree of freedom is defined through a pair of transmission modes of the single photon in each of said two multimode waveguides. Advantageously, this alternative is particularly useful for miniaturizing the apparatus 100.

Still alternatively it is possible to choose two pairs of degrees of freedom of a pair of states of a photon that respect the first and second condition and that instead of a beam splitter and of a position exchanger between the optical paths, use is made of an equivalent of a beam splitter and of an equivalent of a time delay system.

Alternatively, it is possible to choose two degrees of freedom energy and time that respect the first and second condition, wherein the value of the first degree of freedom is defined by the interference filter 20 to select the energy and the value of the second degree of freedom is defined by a time delay established by an optical delay line, wherein the optical delay line comprises an electronic timing circuit, such as for example a trigger, which defines a time axis from the instant at which the photon enters the second generation stage 220.

Alternatively, as shown in FIG. 7, it is possible to choose two degrees of freedom polarization and angular momentum that respect the first and second condition, wherein the first degree of freedom is polarization and the second degree of freedom is defined by means of a Q-plate.

Alternatively, as shown in FIG. 6, it is possible to choose two degrees of freedom momentum and angular momentum that respect the first and second condition, wherein the first degree of freedom is the direction and the second degree of freedom is defined by means of a Q-plate 52.

The Q-plate is an optical device that generates a photon with a defined orbital angular momentum obtained from a photon with a defined circular polarization.

Alternatively, as shown in FIG. 6, the Q-plate 52 can replace the polarizer 51 in the first generation stage 210.

Alternatively, it is possible to choose two degrees of freedom momentum and time that respect the first and second condition, wherein the first degree of freedom is the direction and the second degree of freedom is a time delay established by an optical delay line, such as for example an electronic timing circuit, such as for example a trigger, which defines the time axis from the instant at which the photon enters the second stage 220 of the generation apparatus 200. In this alternative the source 10 can be an attenuated LASER or an incoherent source as described above, but the source 10 must be pulsed with short pulses to maintain a temporal coherence between the selected optical paths. The interference filter 20 in the case of an incoherent source 10 maintains the coherence of the momentum.

Still alternatively, an apparatus 100 can be taken into consideration as shown in FIG. 4 in which the verification apparatus 300 does not comprise the first preparation stage 310 but the alternative second detection stage 320 is instead provided.

The second alternative detection stage 320 comprises the second beam splitter 62 which directs the single photon with equal probability along two orthogonal paths directed to two solid-state photodetectors 85 and 86 such as for example two SPADs such as those described above.

The alternative second detection stage 320 comprises two output collimators 331, 333 and two output waveguides 332, 334. Each output collimator 331, 333 receives the photon from the respective path of the two output paths of the second beam splitter 62. Each output optical fibre 332, 334 transmits the photon to the respective photodetector 85, 86 for it to be detected by means of the computer 400 comprising the at least one memory 401 for storing the data of the two photodetectors 85, 86 and the at least one processor 402 adapted to process the data of the two photodetectors 85, 86 stored in the at least one memory 401.

Still alternatively, the invention can be miniaturized and the discrete components thereof integrated into a photonic integrated circuit that is made on a monolithic or hybrid technological platform, e.g. of glass, lithium niobate, Si, SiN, SiON, InP or other compound semiconductors. The integrated circuit comprising the source apparatus 200 of the present invention comprising a photon source 10 which is preferably a LED which advantageously emits photons in optical band which can be transmitted through waveguides of the integrated circuit. Instead of correlating the path and polarization states as described above, it is possible to correlate other states such as a mode state and a path state to favour the miniaturization of the apparatus.

Alternatively, the photonic integrated circuit can also comprise the verification apparatus 300.

Alternatively, the photonic integrated circuit integrates only the second generation stage 220, i.e. the apparatus 100 provides that the second generation stage 220 is integrated into the integrated photonic circuit.

Alternatively, the photonic integrated circuit also integrates the first generation stage 210 minus the source 10 which is external to the circuit, i.e. that the first generation stage 210 minus the source 10 is integrated into the integrated photonic circuit.

Advantageously, the incoherent LED source does not need to be powered at high power, thus reducing costs, energy consumption, heat dissipation, weight and dimensions of the integrated apparatus.

Advantageously, the incoherent source of quantum-entangled single-photon states can find application as a quantum generator of random numbers for cryptography or as a quantum distributor of access keys for communication security or as a support for the transmission of quantum information.

Advantageously, the generation of quantum-entangled single-photon states allows increasing the energy efficiency of the apparatus since it is not necessary to generate two photons in quantum entanglement.

Advantageously, “intraparticle entanglement” suffers little from decoherence phenomena, see P & Sardak, D. “Rubustness measure of hybrid intra-particle entanglment, discord, and classical correlation with initial Werner state”, Quantum Information Processing 15, 791-807 (2016).

Advantageously, the miniaturization and the low consumption and low weight of the apparatus allows its application in avionics, space, automotive and transport vehicle industry, internet of things (acronym IoT), consumer electronics and all application areas where data must be transmitted securely.

Alternatively, it is possible to provide that the second stage 220 of the source apparatus 200 does not comprise the first mirror 71, since it is not strictly necessary to compact the optical path 31, 32 of the photon.

Advantageously, all the elements of the source apparatus 200 and of the verification apparatus 300 which handle the photons, outside the optical fibres, are kept in a dark box to avoid external interference.

The invention thus conceived is susceptible to many modifications and variants, all falling within the same inventive concept; furthermore, all details can be replaced by equivalent technical elements. In practice, the materials used, as well as the dimensions thereof, can be of any type according to the technical requirements.

1. An apparatus for producing a multiplicity of photons comprising quantum-entangled single-photon states (100), wherein said single photon comprises two quantum-entangled degrees of freedom,
wherein said apparatus (100) comprises a source apparatus (200) of said multiplicity of photons comprising quantum-entangled single-photon states comprising a first generation stage (210) and a second generation stage (220),
wherein said first generation stage (210) comprises a first element (211) comprising a source (10) generating a multiplicity of photons,
wherein said first element (211) selects a first degree of freedom of two degrees of freedom of the single photon, wherein said first degree of freedom comprises only one pair of values, and
a second element (212) that selects a second degree of freedom of two degrees of freedom of the single photon, wherein said second degree of freedom comprises only one pair of values,
wherein said second generation stage (220) generates a coherent superposition of the two degrees of freedom of the single photon,
wherein said second generation stage (220) selects one value of a first and a second of said two degrees of freedom and the selection does not determine the value of the second degree of freedom of said two degrees of freedom.

2. The apparatus according to claim 1, wherein one of said two degrees of freedom is polarization.

3. The apparatus (100) according to claim 2, wherein the other of the two degrees of freedom is the momentum or the direction.

4. The apparatus (100) according to claim 1, wherein said source (10) is an incoherent source selected from the group consisting of: a LED light emitting diode, a visible light lamp, and an infrared thermal source.

5. The apparatus (100) according to claim 4, wherein said first element (211) comprises an interference filter (20) arranged downstream of said source (10) and along an optical path of the multiplicity of photons generated by the source (10).

6. The apparatus (100) according to claim 5, wherein said interference filter (20) is a band-pass filter centered around a specific wavelength that depends on a peak in wavelength of the incoherent source (10).

7. The apparatus (100) according to claim 1, wherein said source (10) of photons is an attenuated LASER.

8. The apparatus (100) according to claim 1, wherein said first generation stage (210) comprises at least one optical fiber (30) which is arranged downstream of the first element (211) and upstream of the second element (212) along an optical path of the multiplicity of photons generated by the source (10),
wherein said at least one optical fiber (30) collects the photons transmitted by the first element (211) and transmits the photons to the second element (212).

9. The apparatus (100) according to claim 8, wherein the first generation stage (210) comprises at least one collimator (37) arranged downstream of said at least one optical fiber (30) along an optical path of the multiplicity of photons generated by the source (10),
wherein said at least one collimator (37) collects the photons transmitted by said at least one input optical fiber (30) and transmits the photons as collimated to the second element (212).

10. The apparatus (100) according to claim 1, wherein said second element (212) comprises a polarizer (51).

11. The apparatus (100) according to claim 1, wherein said first element (211) comprises a polarizer (51).

12. The apparatus (100) according to claim 1, wherein said second element (212) comprises a q-plate (52).

13. The apparatus (100) according to claim 1, wherein said second element (212) comprises an optical delay line.

14. The apparatus (100) according to claim 1, wherein said second generation stage (220) comprises:
at least one first beam splitter (61) arranged downstream of the second element (212) along an optical path of the multiplicity of photons coming out of said second element (212), wherein said at least one first beam splitter (61) generates two paths (31, 32) for said multiplicity of photons, and
a first piezoelectric translation mirror (41) provided to intercept one of said at least two paths (31, 32), wherein said first piezoelectric translation mirror (41) is mounted with a piezoelectric translator and adjusts a relative phase displacement (ξ) between said at least two paths (31, 32).

15. The apparatus (100) according to claim 1, wherein the first element (211) and the second element (212) of said first generation stage (210) comprise four waveguides (33-36) arranged with respect to each other in a geometric configuration adapted to allow the identification of geometric correlations with respect to each other, in such a way that such identification allows to assign a value to both the degrees of freedom of said two degrees of freedom of the single photon.

16. The apparatus (100) according to claim 15, wherein said four waveguides (33-36) represent four optical paths, said four waveguides (33-36) are arranged parallel to each other and lie on a horizontal geometric plane, a geometric line parallel to the four waveguides (33-36), said geometric line acting as a centerline, which is used as a reference and can identify the four waveguides (33-36), such as a first waveguide (33) higher than the centerline, a second waveguide (34) higher than the centerline, a third waveguide (35) lower than the geometric line, a fourth waveguide (36) lower than the centerline, wherein the first top guide (33) is far from the centerline, wherein the second top guide (34) is near the centerline, wherein the first bottom guide (35) is near the centerline, wherein the second bottom guide (36) is far from the centerline, wherein the degrees of freedom of the pair of states of the single photon inserted in the waveguides (33-36) are two for the first top (T) and bottom (B) degree of freedom, and two for the second near (N) and far (F) degree of freedom, wherein top, bottom, near and far refer to the geometric arrangement of the four waveguides (33-36) in relation to the centerline on the geometric plane.

17. The apparatus (100) according to claim 15, wherein said second generation stage (220) comprises:
at least one first beam splitter (61) arranged between two waveguides (33, 34) of said four waveguides (33-36), wherein said at least one first beam splitter (61) directs with equal probability said multiplicity of photons generated by said source (10) between said two waveguides (33, 34) of said four waveguides (33-36), and
at least one position exchanger (45) arranged downstream of said at least one first beam splitter (61), wherein said at least one position exchanger (45) is arranged between two waveguides (34, 35) of said four waveguides (33-36).

18. The apparatus (100) according to claim 1, wherein the first element (211) and the second element (212) of said first generation stage (210) comprise two multimode waveguides arranged with respect to each other in a geometric configuration adapted to allow the identification of geometric correlations with respect to each other, in such a way that such identification allows to assign a value to a first degree of freedom of said two degrees of freedom of the single photon, the value of the second degree of freedom is defined through a pair of transmission modes of the single photon in each of said two multimode waveguides.

19. The apparatus (100) according to claim 1, further comprising an integrated photonic circuit, which the second generation stage (220) is integrated into said integrated photonic circuit.

20. The apparatus (100) according to claim 19 wherein the first generation stage (210), minus the source (10), is integrated into the integrated photonic circuit.

21. An integrated photonic circuit comprising an apparatus for producing single-photon states in quantum entanglement (100) according to claim 1.

22. The integrated photonic circuit according to claim 21, wherein the integrated photonic circuit is made on a monolithic or hybrid technological platform, selected from the group consisting of: glass, lithium niobate, Si, SiN, SiON, InP and other compound semiconductors.
